(19) United States
(12) Patent Application Publication
(10) Pub. No.: US 2006/0050728 A1
(43) Pub. Date: Mar. 9, 2006

(54) Method for bi-directional communication between source device and destination device during allocated channel time

(75) Inventors: Hyun-ah Sung, Seoul (KR); Dae-gyu Bae, Suwon-si (KR); Jin-woo Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/217,322

(22) Filed: Sep. 2, 2005

(30) Foreign Application Priority Data
Sep. 3, 2004 (KR) 10-2004-0070351

(51) Int. Cl. H04L 12/413; H04B 7/005; H04L 12/43

(52) U.S. Cl. 370/448; 370/278; 370/459

(57) ABSTRACT

A method and device for bidirectionally transmitting and receiving data during an allocated channel time using a CSMA/CA contention system are provided. The method includes receiving a first data frame from the destination device, transmitting an acknowledgement (ACK) to the destination device, checking whether a channel is idle for a predetermined waiting time, after the source device transmits the ACK to the destination device, and transmitting a second data frame to the destination device if a channel is idle for a predetermined waiting time.

### CROSS-REFERENCE TO RELATED APPLICATION

This application claims priority from Korean Patent Application No. 10-2004-0070351 filed on Sep. 3, 2004 in the Korean Intellectual Property Office, the disclosure of which is incorporated herein by reference in its entirety.

### BACKGROUND OF THE INVENTION

1. Field of the Invention

The present invention relates to a method and apparatus for communication between wireless devices, and more particularly, to a method and apparatus for transceiving data bi-directionally between two wireless devices during allocated time using a CSMA/CA contention system.

2. Description of the Related Art

Ultra wideband (UWB), which is also known as digital pulse wireless, has been developed by the U.S. Department of Defense for military purposes, and is a wireless technology for transmitting a large amount of digital data over a wide spectrum of frequency bands with low power within a short distance. Standardization of UWB is currently being carried out by a Working Group that establishes the IEEE 802.15.3, i.e. wireless PAN standards. The IEEE 802.15.3 deals with the PHY (physical layer) and media access control (MAC) layer. Recently, research studies for improving the MAC have been active in the field of radio technology.

802.15.3 MAC is characterized by a rapidly established wireless network. Further, 802.15.3 MAC is not based on an AP (Access Point) but rather on an Ad Hoc Network called a Piconet controlled by a PNC (Piconet Coordinator). The 802.15.3 MAC adopts a TDMA (Time Division Multiple Access) system. A MAC frame for exchanging data between devices is embodied in a temporal structure called a superframe as shown in FIG. 1. The superframe is composed of a beacon containing control information, a CAP (Contention Access Period) for transmitting data through backoff, and CTAP (Channel Time Allocation Period) for transmitting data without contention within the allocated time. Among them, CAP can be replaced by MCTA (Management CTA). Currently, competitive access can be made in a CAP through a CSMA/CA (Carrier Sense Multiple Access/Collision Avoidance) system and a channel can be accessed in MCTA through a slotted Aloha method.

CTAP can comprise a plurality of MCTA blocks and a plurality of CTA blocks. CTA (Channel Time Allocation) is classified into two types: i.e., a dynamic CTA and a pseudo-static CTA. The dynamic CTA can be changed in position in each superframe, but cannot be used in a relevant superfrane if the beacon of a superframe is lost. On the other hand, the pseudo static CTA remains unchanged in the same fixed position, and can be used in the fixed position even if the beacon of a superframe is lost. However, the pseudo static CTA cannot be used if a beacon is continuously lost over the number of times corresponding to mMaxLostBeacons. Therefore, since the 802.15.3 MAC is based on the TDMA system capable of ensuring QoS (Quality of Service), it is particularly suitable for multimedia audio/video (A/V) streaming on a home network. Nevertheless, MAC should be still further improved to effectively utilize throughput as well as QoS.

There are two data transmission schemes in 802.15.3 MAC: i.e., an isochronous data transmission scheme and an asynchronous data transmission scheme.

In the isochronous data transmission scheme, a channel time is first allocated from the PNC through a MAC sublayer Management Entity (MLME)-CREATE-STREAM.request. Then a MLME-CREATE-STREAM.confirm and data are actually transmitted during the allocated channel time through MAC-ISOCH-DATA.request and MAC-ISOCH-DATA.confirm, as shown in FIG. 2. The allocated channel time can be obtained by analyzing the beacon, and a device constituting the piconet (hereinafter referred to as “DEV”) can thus know the communication start time and communication end time based on the obtained channel time.

At this instant, a source device (src DEV) and a destination device (dest DEV) are assigned for the allocated channel time. The device for transmitting data in the allocated channel time must be the src DEV, but the device for receiving the data is not necessarily the dest DEV specified in the CTA information. However, a device capable of receiving the data is a device in which an “Always AWAKE bit” or a “listen to source bit” is set to 1.

On the other hand, in the asynchronous data transmission scheme, the src DEV sends a channel time request command frame to the PNC when the data to be transmitted arrive at a MAC layer via MAC-ASYNC-DATA.request, as shown in FIG. 3. Then, when the src DEV knows from the beacon that a requested channel time has been allocated, data are transmitted during the allocated channel time. Similar to the isochronous data transmission scheme, a pair of src DEV and dest DEV are assigned for the allocated channel time and only the assigned src DEV can transmit data during the allocated channel time. In addition, as an alternative method for sending asynchronous data, there is provided a method for sending frames using a backoff algorithm in the Contention Access Period (CAP).

To ensure the reliability of data transmission, TCP/IP is configured such that DEV1 transmits a frame to DEV2 and DEV2 returns an ACK frame (an ACK frame at the TCP/IP level, not an Inm-ACK frame as shown in FIGS. 2 and 3) to DEV1. A problem occurring when a data transmission mechanism provided by the 802.15.3 MAC is directly used in the TCP/IP having this mechanism will be described in detail as follows.

First, when TCP/IP data are isochronously transmitted, DEV1 will send DEV2 a frame for establishing a connection with DEV2. To this end, DEV1 first sends a PNC MLME-CREATE-STREAM.request to request channel time allocation in which the src DEV is DEV1 and the dest DEV is DEV2. When the PNC allocates channel time and sends a beacon containing information on the channel time, DEV1 reads information on the beacon and transmits the frame to DEV2 at the designated time. To send a response frame to the frame transmitted from DEV1, DEV2 requests channel time allocation in which the src DEV is DEV2 and the dest DEV is DEV1. Similarly, when the PNC allocates channel time and sends a beacon containing information on the channel time, DEV2 reads information on the beacon and transmits a response frame to DEV1 at the designated time. Since the channel time continues to be allocated until MLME-TERMINATE-STREAM.request is received, the data and ACK frame exchanged between DEV1 and DEV2 will be sent at the time allocated to the pair of src DEV and dest DEV according to the channel time information in the beacon. However, according to the characteristics of TCP/IP, until a sender receives an ACK frame after sending a data frame, the sender does not send other frames. Only the src DEV specified in the channel time allocation from the beacon can be a sender of the channel time in 802.15.3 MAC. Therefore, DEV2 should send an ACK frame at the TCP/IP level after the channel time in which the src DEV is DEV2. Consequently, although the time allocated to DEV1 and DEV2 is remaining after DEV1 sends data, DEV1 cannot receive an ACK frame from DEV2 during the time left, and thus, a waste of channel time occurs.

Second, a case where the TCP/IP frame is asynchronously transmitted will be discussed. When asynchronous data are sent to the Contention Access Period, the PNC may or may not allocate the CAP to a superframe. Furthermore, even though there is an allocated CAP, the method of sending the TCP/IP frame using the CAP does not ensure reliable transmission of the TCP/IP frame since the determination of whether the asynchronous data can be sent or not takes place during the period according to a criterion set by the PNC. Next, to send asynchronous data through channel time allocation, a MAC-ASYNCH-DATA.request should be used as described above. As shown in FIG. 3, however, a data frame should be transmitted only after the channel time request command has been sent to the PNC and the channel time has been subsequently allocated. Such a successive transmission of data results in a waste of bandwidth. In addition, since it cannot be ensured that the requested channel time would be allocated even when the channel time allocation is requested, a device that attempts to transmit data should wait until at least the next superframe whenever each data frame is sent. Therefore, time delays will always occur.

The aforementioned problems may occur not only in TCP/IP but also when a protocol for exchanging data between two DEVs is executed in an upper layer of the 802.15.3 MAC.

### SUMMARY OF THE INVENTION

Exemplary embodiments of the present invention provide a method for efficiently performing communication between two devices during allocated channel time according to the IEEE 802.15.3 standard. To accomplish this, channel time allocation (CTA) defined in the IEEE 802.15.3 is used for bidirectional transmission.

That is, exemplary embodiments of the present invention provide a method for efficiently supporting a bidirectional data transmission protocol such as Transmission Control Protocol (TCP) by using allocated channel time bidirectionally without making any change to the existing 802.15.3 MAC specification.

According to an aspect of the present invention, there is provided a method of transmitting data from a source device to a destination device during an allocated channel time, the method including receiving a first data frame from the destination device, transmitting an acknowledgement (ACK) to the destination device, checking whether a channel is idle for a predetermined waiting time, after the source device transmits the ACK to the destination device, and transmitting a second data frame.

According to another aspect of the present invention, there is provided a method of transmitting data from a source device to a destination device during an allocated channel time, the method including receiving a first data frame from the destination device, checking whether a channel is idle for a predetermined waiting time, after the source device receives the first data frame from the destination device, and transmitting a second data frame to the destination device if a channel is idle for a predetermined waiting time.

According to yet another aspect of the present invention, there is provided a method of transmitting data from a source device to a destination device during an allocated channel time, the method including receiving a first data frame from the destination device, transmitting an ACK for the first data frame to the destination device, checking whether a channel is idle for a predetermined waiting time, after the source device transmits the ACK to the destination device, actuating a first backoff counter according to a backoff algorithm after the predetermined waiting time elapses, and transmitting a second data frame to the destination device when the first backoff counter reaches zero.

According to a further aspect of the present invention, there is provided a method of transmitting data from a destination device to a source device during an allocated channel time, the method including receiving a first data frame from the source device, checking whether a channel is idle for a predetermined waiting time, after the destination device receives the first data frame the source device, actuating a first backoff counter according to a backoff algorithm after the predetermined waiting time elapses, and transmitting a second data frame to the source device when the first backoff counter reaches zero.

According to yet a further aspect of the present invention, there is provided a method of transmitting data from a destination device to a source device during an allocated channel time, the method including receiving a first data frame from the source device, checking whether a channel is idle for a predetermined waiting time, after the destination device receives the first data frame the source device, actuating a first backoff counter according to a backoff algorithm after the predetermined waiting time elapses, and transmitting a second data frame to the source device when the first backoff counter reaches zero.

### BRIEF DESCRIPTION OF THE DRAWINGS

The above and other aspects of the present invention will become more apparent by describing in detail exemplary embodiments thereof with reference to the attached drawings in which:

FIG. 1 illustrates a conventional superframe structure;

FIG. 2 illustrates a conventional process for requesting channel time allocation (CTA);

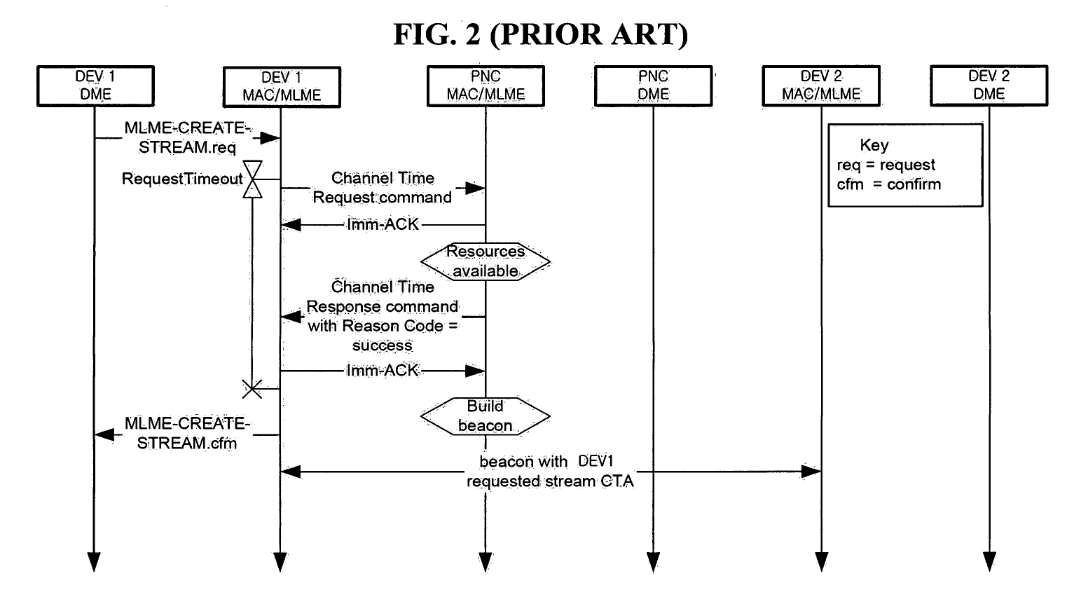

FIG. 3 illustrates a conventional process for transmitting asynchronous data;

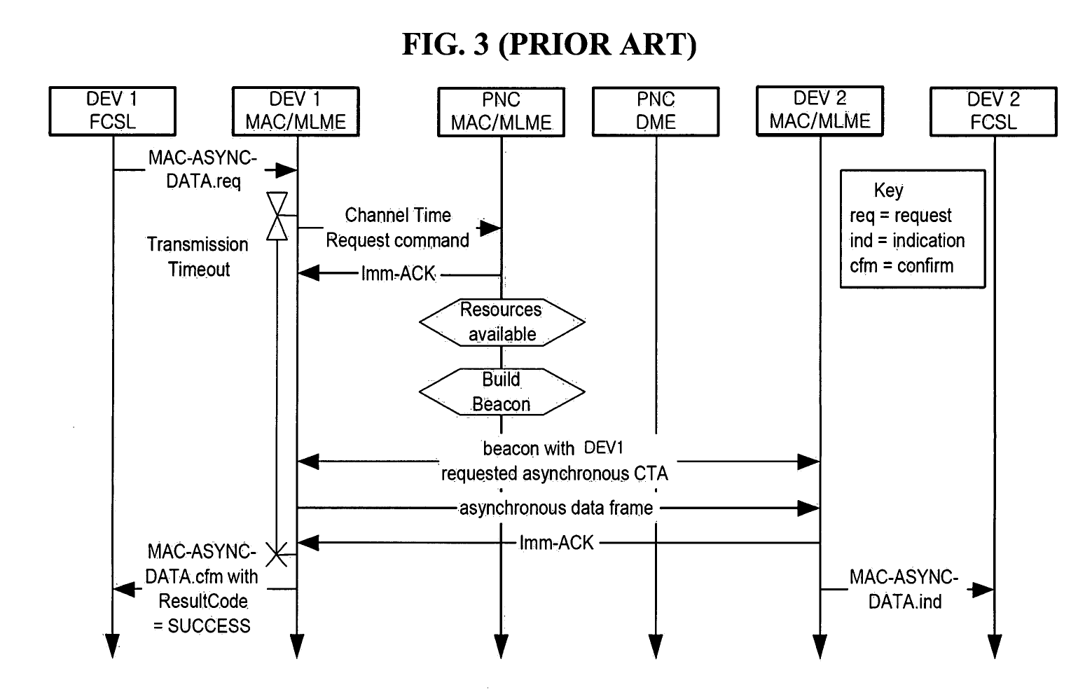

FIG. 4 shows an example of bidirectionally transmitting and receiving data between devices within an allocated channel time according to an exemplary embodiment of the present invention;

FIG. 5 shows an example of bidirectionally transmitting and receiving data between devices within an allocated channel time according to another exemplary embodiment of the present invention;

FIG. 6 is a block diagram of a wireless device according to an exemplary embodiment of the present invention;

FIG. 7 is a flowchart illustrating the overall operation of an exemplary embodiment of the present invention;

FIG. 8 is a view showing the structure of a superframe and a data transmission process when unidirectional transmission is made according to the prior art; and

FIG. 9 is a view showing a data transmission process when bi-directional transmission is made within a given CTA according to an exemplary embodiment of the present invention.

### DETAILED DESCRIPTION OF THE INVENTION

The present invention will now be described more fully with reference to the accompanying drawings, in which exemplary embodiments of the invention are shown.

The IEEE 802.15.3 standard defines four different interframe spaces (IFSs): a minimum IFS (MIFS), a short IFS (SIFS), a backoff IFS (BIFS), and a retransmission IFS (RIFS).

The actual IFS (MIFS, SIFS, BIFS, and RIFS) values are determined by the characteristics of physical layer. For example, when a 2.4 GHz physical layer is used, the IFSs are defined as shown in Table 1 below. Here, pPHYMIFSTime and pPHYSIFSTime respectively denote the time between successive frames and receive-to-transmit (RX-to-TX) turnaround time. The PHY parameter pCCADetectTime denotes the clear channel assessment (CCA) detection time.

TABLE 1

| MAC Parameter | Corresponding PHY Parameter |
|---|---|
| MIFS | pPHYMIFSTime |
| SIFS | pPHYSIFSTime |
| BIFS | pPHYSIFSTime + pCCADetectTime |
| RIFS | 2 * pPHYSIFSTime + pCCADetectTime |

An immediate acknowledgement (Imm-ACK) frame and a delay acknowledgement (Dly-ACK) frame are transmitted after transmission of the previous frame requiring an ACK. The MIFS is used as an allowed time between a frame with a No-ACK or Dly-ACK policy set and its successive frame. Meanwhile, when a source device (src DEV) does not receive an imm-ACK frame within a predetermined timeout period after sending a frame with an Imm-ACK policy set during a channel time allocation period (CTAP), the src DEV retransmits the same frame. The RIFS refers to a timeout period from transmission up to retransmission of a frame.

In the conventional IEEE 802.15.3 standard, the CSMA/CA (Carrier Sense Multiple Access/Collision Avoidance) contention system is adopted only in a CAP (Contention Access Period), and the source device (src DEV) transmits data to the destination device (dest DEV) without contention in each CTA within a CTAP (Channel Time Allocation Period). In the CTA, the device for transmitting data in the CTA must be the src DEV, but the device for receiving the data is not necessarily the dest DEV. That is, when the CTA is left, the src DEV is capable of transmitting data to other devices.

In an exemplary embodiment of the present invention, however, the src DEV and the dest DEV (hereinafter, simply referred to as “two DEVs”) contend with each other. As a result of channel contention, a DEV that has won priority transmits data to the other DEV. In such a manner, data can be transmitted bi-directionally during the given CTA.

As described above, the basic media access mechanism is based on collision avoidance (CSMA/CA) protocol during each CTA period. In order to minimize collision, the transmitting DEV senses whether the medium is idle, that is, whether the channel is idle, during a random time. A MAC layer uses ‘CCA capabilities’ of a PHY layer to sense whether a medium is idle or busy. The transmitting DEV starts transmission only when the medium is idle after the random time passes. The waiting random time is called a backoff.

During each CTA period, the two DEVs transmit one MAC frame once using the backoff. However, an Imm-ACK frame is an exceptional case. That is, if an SIFS passes after transmitting a MAC frame having an Immediate ACK policy, an Imm-ACK is immediately transmitted without contention.

The two DEVs cannot transmit data in a CTA period other than the corresponding CTA periods. Thus, if a MAC frame is to be transmitted, the two DEVs determine whether the remaining time of the corresponding CTA is designated for receiving the MAC frame to be transmitted, an ACK frame, and two SIFS periods, and only when the CTA is so designated, the MAC frame is transmitted.

An exemplary backoff algorithm used in an exemplary embodiment of the present invention will now be described in detail. In an exemplary embodiment of the present invention, retry_count is one among integers between 0 and 3. A loop counter (retry_count) is set to zero and is incremented by one as the number of retransmission attempts increases, with the proviso that the retry_count does not exceed 3. In addition, a backoff_window (retry_count) is a function of determining the size of a backoff_window. For example, when retry_count values are 0, 1, 2, and 3, the backoff_window has sizes of 7, 15, 31, and 63, respectively. As the number of retransmission attempts increases, the increased backoff_window reduces collision probability. In an exemplary embodiment of the present invention, bw_random (retry_count) is an integer randomly selected from a range between 0 and backoff_window (retry_count). A random number generated by a DEV is statistically uncorrelated with a random number generated by another DEV.

The two DEVs wait for a predetermined waiting period before transmitting and then perform a backoff algorithm if the medium is idle. The two DEVs set the bw_random (retry_count) to their backoff counters, and the respective counters are decremented by one over time. The counters are decremented during the corresponding CTA periods only. While CTA periods of other DEVs elapse, the two DEVs stop decreasing their counters.

In the waiting period, a waiting time set to the src DEV is defined as Tsrc, and a waiting time set to the dest DEV is defined as Tdest. The waiting times may be the same or different from each other. However, when the Imm-ACK policy is used, the waiting times must be longer than RIFS that is a timeout period from transmission up to retransmission of a frame. In addition, when the No-ACK policy is used, the waiting times must be longer than a MIFS, which is a minimum time required between a frame and its successive frame.

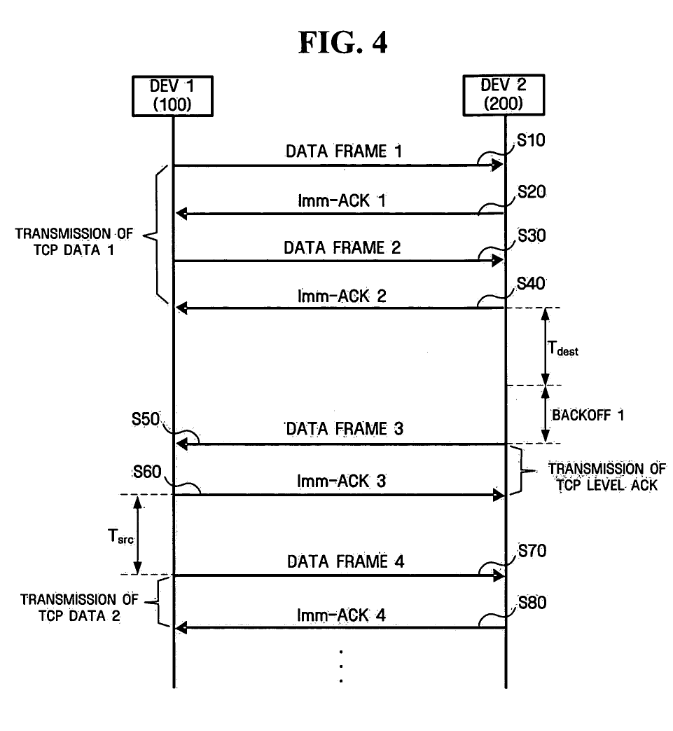

FIG. 4 is a flowchart illustrating a data transmission process according to an exemplary embodiment of the present invention.

A DEV1 100 that is a src DEV may transmit data to a DEV2 200 that is a dest DEV or another DEV within the same piconet in its allocated CTA. Assume that DEV1 100 sends data from a layer above a MAC to DEV2 200. In addition, assume that each data frame has an Imm-ACK policy. To adopt the exemplary embodiment of the present invention, DEV1 100 and DEV2 200 may contend with each other to determine which will first send a data frame in the corresponding CTA. However, since there had already been data to be sent from DEV1 100 to DEV2 200, DEV1 100 must have already sent the PNC a CTA request frame, thus it is desirable to give priority for sending the first data, to DEV1 100 without contention.

First, DEV1 100 will transmit TCP data 1 consisting of two data frames to DEV2 200. Since the TCP data 1 is segmented into data frames 1 and 2, the data frames 1 and 2 must be sent to DEV2 200, respectively.

DEV1 100 transmits the data frame 1 to DEV2 200 in step S10, and receives Imm-ACK 1 from DEV2 200 in step S20. After receiving the Imm-ACK 1, DEV1 100 continuously (specifically after SIFS elapses) transmits the data frame 2 to DEV2 200 in step S30. In step S40, DEV1 100 receives an Imm-ACK 2 for the data frame 2 from DEV2 200. Although DEV2 200 takes part in contention in step S30, it is defeated in the contention because DEV1 100 is granted the exclusive right to transmit data frame 2 to DEV2 200 in step S30 immediately after receiving the Imm-ACK 1.

Thereafter, DEV1 100 waits for a TCP level ACK from DEV2 200. Accordingly, DEV2 200 checks whether the medium is idle during a Tdest period. After the Tdest period elapses, a backoff algorithm is performed. After a predetermined backoff period 1 elapses, DEV2 200 transmits a data frame 3 to DEV1 100 in step S50, and receives an Imm-ACK 3 for the data frame 3 from DEV 1 100 in step S60. The data frame 3 contains the TCP level ACK. Here, since the TCP level ACK appears to be MAC data from the viewpoint of an MAC stage, it is indicated by data frame 3.

Subsequently, since DEV2 200 has no more data frame to send, it waits. Thus, DEV1 100 checks whether the medium is idle during a Tsrc period. After the Tsrc period elapses, a backoff algorithm is performed, like in the case of DEV2 200. Actually, DEV1 100 has requested the PNC to send the corresponding CTA. Since DEV1 100 is expected to transmit a large amount of data during the CTA period, a backoff operation may not be performed on DEV1 100 to give priority to DEV1 100 as a src DEV over DEV2 200. As described above, DEV1 100 waits for a Tsrc period before transmitting a data frame. This is because the DEV 2 200 just transmitted data frames, and thus the two DEVs need to contend with each other. If DEV1 100 transmitted a data frame immediately before, data frames to be transmitted by DEV1 100 are continuously transmitted, like in step S30.

After DEV1 100 transmits the Imm-ACK 3 for the data frame 3 to DEV2 200 in step S60, it is checked whether the medium is idle for the Tsrc period and a data frame 4 is then transmitted in step S70. In step S80, DEV1 100 receives an Imm-ACK 4 for the data frame 4 from DEV2 200. Next, the same process is repeated until there is no time remaining in a CTA.

The same process is repeated until channel time allocated to the two DEVs ends.

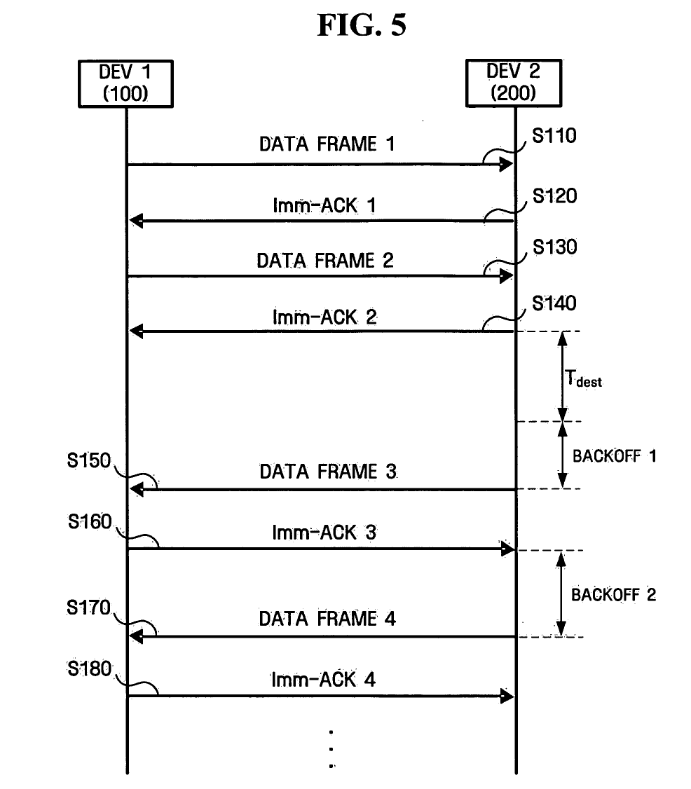

FIG. 5 is a flowchart illustrating a data transmission process according to another exemplary embodiment of the present invention.

Steps S110 through S160 are the same as steps S10 through S60, and an explanation thereof will not be given.

DEV2 200 that has received the Imm-ACK 3 from DEV1 100 in step S60, transmitted the data frame 3 to DEV2 200 immediately before in step S60. Thus, if the medium is idle, DEV2 200 directly passes through a backoff period 2 for the data frame 4 without waiting of the Tsrc period. While DEV2 200 passes through a backoff period 2, DEV1 100 waits until the Tsrc period elapses. Any DEV will win channel contention that has a smaller value of the backoff period 2 or the Tsrc period.

If DEV2 200 has won the channel contention, it transmits the data frame 4 subsequent to the data frame 3 in step S170 and receives the Imm-ACK 4 from DEV1 100 in step 180. If DEV1 100 has won the channel contention immediately after step S160, it will transmit the data frame 4. Then, DEV2 200 will hand over an opportunity for transmitting the data frame 4 next time.

Although the description of FIGS. 4 and 5 has been made on the assumption of Imm-ACK policy, the invention is not limited thereto. That is, the present invention can be applied to a No-ACK policy, which is substantially the same as those described in FIGS. 4 and 5 except for the Imm-ACK transmission process and an explanation thereof will not be given.

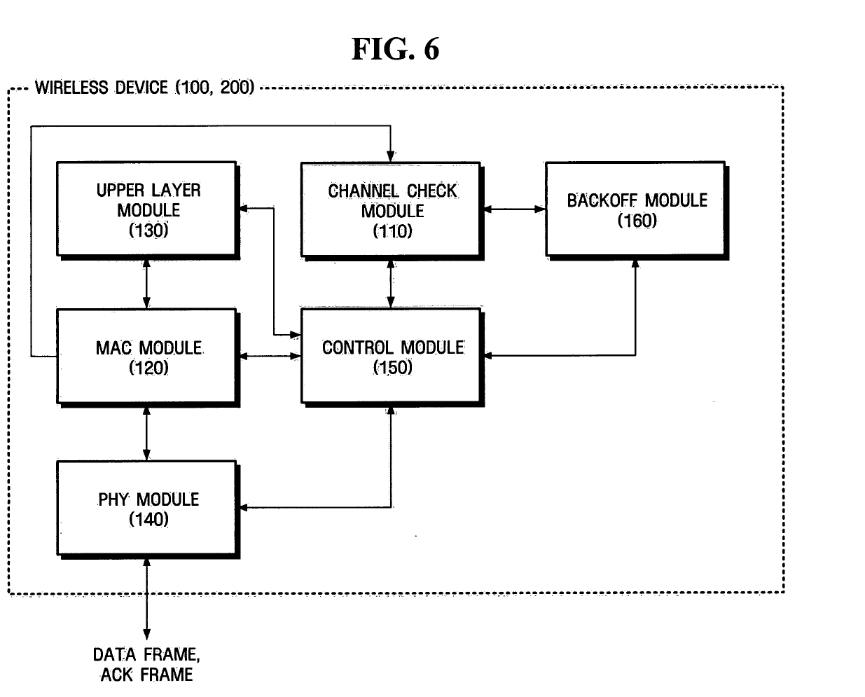

FIG. 6 is a block diagram of a wireless DEV100 (200) according to an exemplary embodiment of the present invention. Referring to FIG. 6, the wireless DEV100 (200) includes a channel check module 110, a MAC module 120, an upper layer module 130, a PHY module 140, a control module 150, and a backoff module 160.

The channel check module 110 checks whether a channel is idle for a predetermined waiting period. Use of ‘CCA (Clear Channel Assessment) capabilities’ of a PHY layer allows a MAC layer to check whether the channel is idle or busy. When the wireless DEV 100 (200) is a src DEV, the waiting period is Tsrc. When the wireless DEV 100 (200) is a dest DEV, the waiting period is Tdest. In the former case, after Tsrc elapses, the wireless DEV 100 (200) does not pass through a backoff period. In the latter case, after Tdest elapses, the wireless DEV 100 (200) must pass through a backoff period. Thus, if it is confirmed that the channel is idled during the Tdest period, the channel check module 110 notifies the backoff module 160 of the fact that the channel is idle.

The MAC module 120 manages operation at a MAC (Media Access Control) layer. That is, the MAC module 120 receives a MSDU (MAC Service Data Unit) from the upper layer module 130, adds the MAC header to the MSDU, and passes the resulting frame to the PHY module 140. The MAC module 120 also reads a MAC header in a data frame received from the PHY module 140, removes the MAC header from the data frame, and transmits the result to the upper layer module 130. When the frame received from the PHY module 140 includes only a MAC header like an Imm-ACK, the MAC module 120 does not transmit it to the upper layer module 130.

The upper layer module 130 generates a MSDU and transmits the MSDU to the MAC module 120 while receiving data from which a MAC header has been removed from the MAC module 120. The upper layer module 130 manages a network layer above a logical link control (LLC) layer, e.g., a TCP/IP layer.

The PHY module 140 manages operation at a Physical Layer. That is, the PHY module 140 receives a MAC Protocol Data Unit (MPDU) from the MAC module 120 to generate a Packet Protocol Data Unit (PPDU) and a radio signal containing the PPDU for transmitting the same to the MAC module 120. It also receives a signal through a wireless medium and processes the signal that is then transmitted to the MAC module 120. The PHY module 140 is subdivided into a base band processor and a radio frequency (RF) module.

The control module 150 controls the operation of other modules within the wireless DEV100 (200) and may be implemented by a central processing unit (CPU), a microcomputer, or the like. When the backoff module 160 is informed that the backoff counter reaches zero, the control module 150 controls the MAC module 120 and the PHY module 140 to transmit data frames.

The backoff module 160, installed in the dest DEV 200, performs a backoff operation based on CSMA/CA, after the Tdest period or while the dest DEV is continuously transmitting data frames. The backoff module 160 sets the backoff counter based on the backoff algorithm and when the backoff counter reaches zero, notifies the control module 150 of the backoff counter having reached zero.

The backoff algorithm has been described above in detail and an explanation thereof will not be given.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

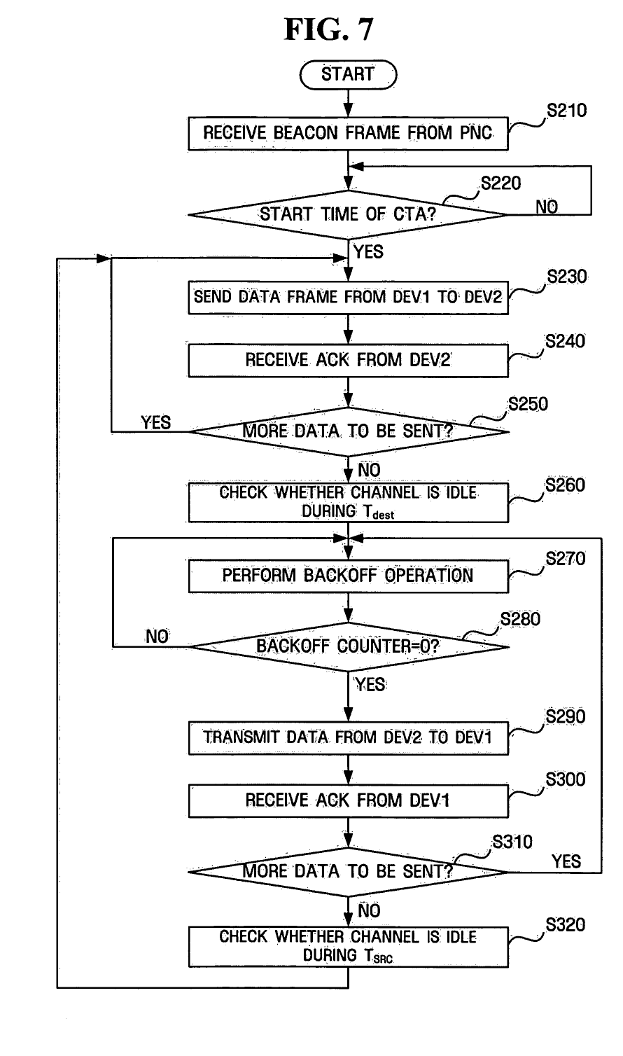

FIG. 7 is a flowchart illustrating the overall operation of an exemplary embodiment of the present invention.

First, DEV1 100 generates a command frame requesting channel time, i.e., a channel time request frame, and sends the channel time request frame to a PNC. The PNC generates a beacon frame using information contained in the channel time request frame and broadcasts the beacon frame to DEVs in the same piconet. Thus, in step S210, DEV1 100 that is a src DEV and DEV2 200 that is a dest DEV receive the beacon frame.

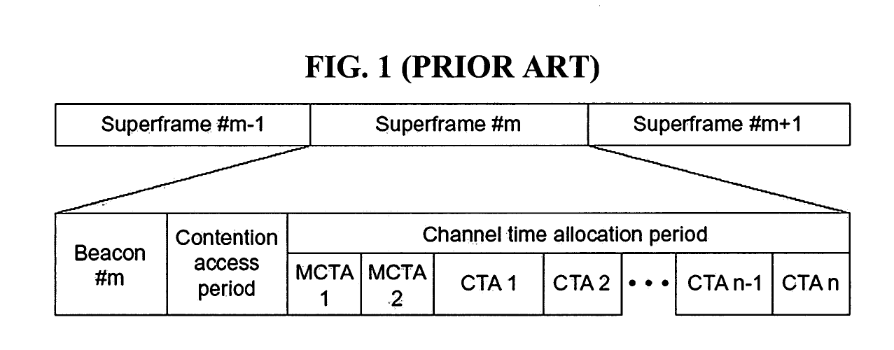

As illustrated in FIG. 1, the beacon frame consists of at least one CTA block, each block defining the start time and the duration of CTA and the respective IDs of the src DEV (DEV1 100) sending data during a CTA and the dest DEV (DEV2 200) receiving data during a CTA.

Upon the arrival of the start time of CTA during which DEV1 100 communicates with DEV2 200 (YES in step S220), DEV1 100 sends a data frame to DEV2 200. In step S230, DEV1 100 sends the data frame to DEV2 200. In step S240, DEV1 100 receives an ACK from DEV2 200. When the data frame adopts a No-ACK policy, step S240 may be skipped.

If there is more data to be sent (YES in step S250), the process returns to the step S230. Here, since only an SIFS, that is, a RX-to-TX turnaround time is required from reception of the ACK to transmission of another data frame, there is no probability of DEV2 200 taking part in channel contention.

If there is no more data to be sent (NO in step S250), DEV1 100 waits and performs no further transmitting operation. Subsequently, DEV2 200 is able to send a data frame.

However, since DEV2 200 is not in a position to know whether DEV1 100 has more data to send or not, in step S260, it must check whether a channel is idle during a Tdest period. When the backoff counter reaches zero (YES in step S270), DEV2 200 sends the data frame.

In step S290, DEV2 200 transmits a data frame to DEV1 100 and receives an ACK from DEV1 100 in step S300. Next, if there is more data to be sent (YES in step S310), the process returns to the step S270. In this manner, when DEV1 100 transmitted a data frame immediately before, DEV2 200 passes through the Tdest period and the backoff period. However, when DEV1 100 transmitted a data frame immediately before, DEV2 200 passes through only the backoff period without waiting until the Tdest period elapses. While DEV2 200 performs the backoff operation after receiving ACK in step 300, DEV1 100 sends the ACK to DEV2 200 and then checks whether a channel is idle during the Tsrc period.

Therefore, if the Tsrc period is shorter than the backoff period, DEV1 100 may be granted the exclusive right to transmit data. In this case, DEV2 200 having more data to be transmitted waits for a retransmission opportunity. DEV1 100 may well be prioritized because the CTA was originally sent from the PNC by the request of DEV1 100 and DEV2 200 is just given a transmission opportunity additionally in order to effectively use the CTA. Thus, DEV1 100 does not pass through a backoff period even after waiting for the Tsrc period. If necessary, Tsrc is set to be smaller than Tdest, thereby increasing a possibility of acquiring a transmission opportunity.

According to the exemplary embodiment shown in FIG. 7, if there is data to be transmitted in step S3 10, the process returns to step S270 to perform a backoff operation. In another exemplary embodiment, the process returns to step S290 for pPHYMIFSTime of DEV2 200. When DEV2 200 continuously transmits data frames in such a manner, DEV1 100 cannot take part in channel contention.

In step S310, if DEV2 200 has no more data to be sent (NO in step S310), DEV2 200 waits and performs no further transmitting operation. Subsequently, DEV1 200 is able to send a data frame.

However, since DEV1 100 is not in a position to know whether DEV2 200 has more data to be sent or not, in step S320, it must check whether a channel is idle during a Tsrc period, that is, the process returns to step S230. As described above, a backoff operation may not be performed on DEV1 100 to give priority to DEV1 100 over DEV2 200. However, like in the case of DEV2 200, a backoff operation may be performed on DEV1 100.

Steps S210 through S320 are performed from the start time to end time of the relevant CTA. Further, if the end time of CTA arrives during any of the above steps, the process of FIG. 7 is terminated.

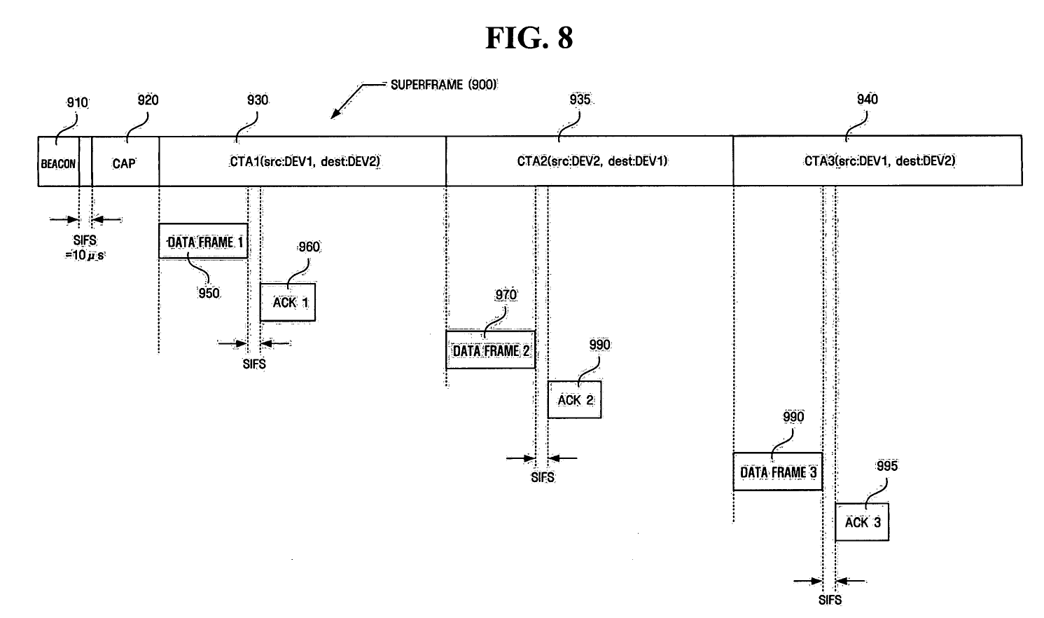

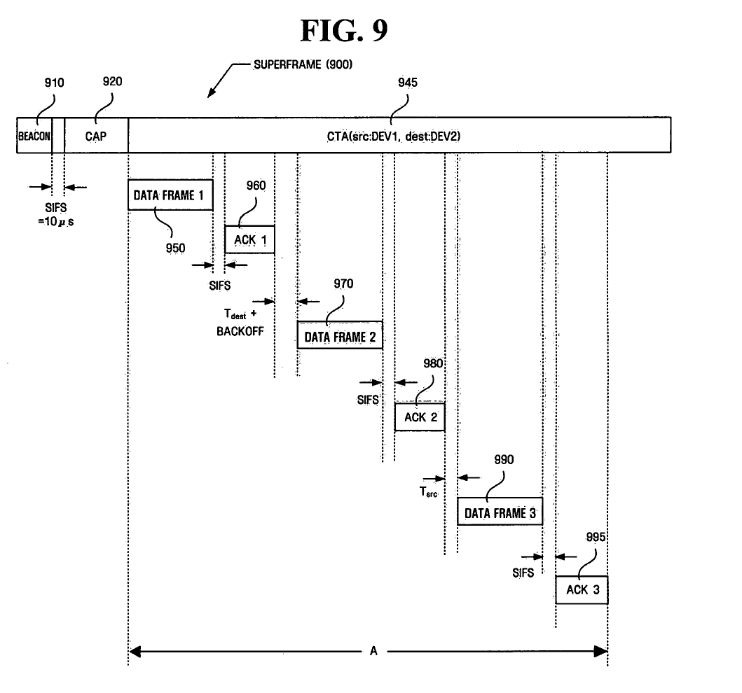

Hereinafter, a difference in transmission efficiency between unidirectional transmission in the CTA according to the prior art and bi-directional transmission in the CTA according to the present invention is compared with reference to FIGS. 8 and 9.

FIG. 8 is a view showing the structure of a superframe 900 and a data transmission process when unidirectional transmission is made according to the prior art. When two devices DEV1 and DEV2 exist on a piconet and DEV1 attempts to transmit a stream to DEV2 using TCP/IP, a data frame is transmitted from DEV1 and DEV2 and an ACK frame for the data frame is transmitted from DEV2 to DEV1. It is assumed that an ACK policy for use in a MAC layer is an IMM-ACK policy, the superframe duration is 10 ms, and CAP is 1 ms. Further, it is also assumed that the transmission rate of a MAC header is 22 Mbps and the transmission rate of a frame payload is 55 Mbps.

If both DEV 1 and DEV2 have requested a super-rate CTA with a rate factor of 1, the superframe 900 will be used as illustrated in FIG. 8. It is now assumed that there are no information elements (IE) other than CTA IE and a beacon service ID BSID IE in the superframe 900 as shown in FIG. 8.

A beacon 910 is composed of a MAC header of 10 bytes, piconet synchronization parameters of 21 bytes, a CTA IE of 16 bytes (because this example has information on two CTAs), and a BSID IE Of 20 bytes (it is assumed that the size of BSID is 10 bytes). As a result of the calculation in the following Table 2, it takes about 0.012 ms to transmit the beacon as constructed.

TABLE 2
Header transmission time: (10 × 8bits) × 1000 ms/22 Mbps = 0.0036 ms
Payload transmission time: (21 + 16 + 20) × 8bits × 1000 ms/55
Mbps = 0.0082 ms

The transmission durations of CTA1 930, CTA2 935 and CTA3 940 depend on the size of the TU (time unit) and the desired number of TUs that DEV1 and DEV2 request the PNC to send, respectively. The TU should transmit at least one frame according to the specified ACK policy. If the remaining time except for beacon transmission time and CAP 920 is allocated to each of DEVs, CTA 1 930 in which the src DEV is DEV1 and the best DEV is DEV2 and the CTA2 935 in which the src DEV is DEV2 and the dest DEV is DEV1 will be allocated as illustrated in FIG. 8 because it was assumed that both DEV1 and DEV2 have requested a super-rate CTA with a rate factor of 1. The number of time units TUs requested by DEV1 and DEV2 and the desired number of TUs. During one TU, at least one frame must be transmitted according to a specified ACK policy. When all of the time excluding beacon transmission time and a CAP 920 is allocated to DEV1 and DEV2, CTA1 930 in which a src DEV is DEV1 and a dest DEV is DEV2 and CTA2 935 in which a src DEV is DEV2 and a dest DEV is DEV1 are allocated to DEV1 and DEV2, respectively, since DEV1 and DEV2 all request a super-rate CTA with a rate factor field set to 1. The durations of CTA1 930, CTA2 935 and CTA3 940 may vary depending on the number of TUs requested by each DEV and a CTA algorithm performed by a PNC.

When the CTA1 930 starts, DEV1 transmits data frame 1 to DEV2. In this case, a payload in the data frame 1 950 is a TCP/IP data frame. When the data frame 1 950 is 2,048 bytes in length, which is the maximum length of a frame (excluding a MAC header), transmission time of the data frame 1 950 is about 0.3015 ms as shown in the following Table 3.

TABLE 3
(MAC header transmission time + (2048 × 8 bits) × 1000 ms/55 Mbps =
0.0036 ms + 0.2979 ms = 0.3015 ms

ACK1 960 is an ACK frame that is sent from DEV2 to DEV1 and transmitted according to the ACK policy of the MAC in the MAC layer. Since the ACK frame is composed of only a MAC header in IEEE 802.15.3, it will take 0.0036 ms to transmit the ACK frame.

Since frames are transmitted through the TCP/IP in a higher layer of the MAC layer in this example, the DEV1 can no longer transmit a new frame if it does not receive the ACK frame of a TCP/IP level from DEV2. When DEV1 transmits a frame to DEV2 using TCP/IP, DEV2 should send an ACK frame for the transmitted frame. Since this ACK frame is transmitted in the higher layer of the MAC layer separately from an ACK (for example, the Imm-ACK) that is sent in the MAC layer, it will be processed in the same way as other data frames in view of the MAC layer. As shown in FIG. 8, a second frame represents an ACK frame of the TCP/IP level which DEV2 transmits to DEV1. Even though DEV2 attempts to send the second frame to DEV1, DEV2 should wait until the channel time in which DEV2 itself is allocated as the src DEV. Accordingly, the second frame 970 can be transmitted only when the start time of CTA2 940 arrives. ACK2 980 is an ACK frame of a MAC layer level that will be transmitted according to the ACK policy of the MAC layer.

As described above, when the CTA system of the existing 802.15.3 is employed, one frame with the size of 2048 bytes is transmitted from DEV1 to DEV2 during the superframe of 10 ms and vice versa. Thus, a considerable waste of the CTA may occur.

FIG. 9 is a view showing a data transmission process when bi-directional transmission is made within a given CTA according to an exemplary embodiment of the present invention. Similarly in FIG. 8, it is also assumed that the entire remaining time except for the beacon transmission time and CAP 920 is allocated to the DEVs. The first frame 950 is a TCP/IP data frame that will be sent from DEV1 to DEV2 and the second frame 970 is an ACK frame of a TCP/IP level that will be sent from DEV2 to DEV1. It is also assumed that one TOKEN frame 990 has been transmitted between the first and second frames in consideration of a processing time consumed until the second frame 970 is transmitted. Then, the time A taken from when one TCP/IP data frame is sent from DEV1 to DEV2 to when an ACK frame of a TCP/IP level for the data frame is received is calculated as illustrated in the following Table 4.

TABLE 4
A = Transmission time of data frame 1 + SIFS + Transmission time of
ACK 1 + Tdest + Mean backoff + Transmission time of data frame 2 +
SIFS + Transmission time of ACK 2 + SIFS + Transmission time of data
frame 3 + SIFS + Transmission time of ACK 3 = 0.3015 ms + 0.01 ms +
0.0036 ms + 0.03 ms + 0.05 ms + 0.3015 ms + 0.01 ms + 0.0036 ms +
0.03 ms + 0.3015 ms + 0.01 ms + 0.0036 ms = 1.0553 ms

Accordingly, the result illustrated in the following Table 5 will be obtained by dividing a value, which is obtained by subtracting the transmission time of the beacon 910 and CAP 920 from the superframe 900 of 10 ms, by the time A.

TABLE 5

(10 − 0.012 − 0.01 − 1)/1.0553 ≈ 8 frames

According to this result, DEV1 can send DEV2 16 (8×2) frames, each of which has a size of 2048 bytes during a unit superframe and vice versa. Of course, if the channel time is requested to the PNC with a CTA rate factor designated as a number exceeding 1, more data than can be transmitted in FIG. 8 can be transmitted. However, since the channel time allocation can be changed according to rate factors or the channel time allocation algorithm of the PNC, and it cannot be ensured that the maximum channel time can always be available, it is more efficient to employ a channel time having a bi-directional transmission type as proposed in exemplary embodiment of the present invention.

According to an exemplary embodiment of the present invention, bi-directional communication is allowed between two devices during a given CTA without modifying the existing MAC protocol defined in the IEEE 802.15.3 standard.

In addition, the method according to an exemplary embodiment of the present invention allows devices in a piconet to more efficiently use given CTAs, thereby improving the overall throughput of the piconet.

Although the exemplary embodiments of the present invention have been described with reference to the accompanying drawings, it can be understood by those skilled in the art that the present invention can be implemented in the other specific forms without modifying or changing the technical spirit and essential features thereof. Therefore, it should be understood that the aforementioned exemplary embodiments are not restrictive but illustrative in all aspects. The scope of the present invention should be defined by the appended claims, and all changes or modifications made from the spirit and scope of the invention and equivalents thereof should be construed as falling within the scope of the invention.

What is claimed is:

1. A method of transmitting data from a source device to a destination device during an allocated channel time, the method comprising:
receiving a first data frame from the destination device;
transmitting an acknowledgement (ACK) to the destination device;
checking whether a channel is idle for a predetermined waiting time, after the source device transmits the ACK to the destination device; and
transmitting a second data frame to the destination device if the channel is idle for the predetermined waiting time.

2. The method of claim 1, wherein the predetermined waiting time is set to be longer than a retransmission interframe space (RIFS) defined according to IEEE 802.15.3.

3. The method of claim 1, wherein in the checking, clear channel assessment (CCA) capabilities of a physical (PHY) layer is used to check whether the channel is one of idle and busy.

4. A method of transmitting data from a source device to a destination device during an allocated channel time, the method comprising:
receiving a first data frame from the destination device;
checking whether a channel is idle for a predetermined waiting time, after the source device receives the first data frame from the destination device; and
transmitting a second data frame to the destination device if the channel is idle for the predetermined waiting time.

5. The method of claim 1, wherein the predetermined waiting time is set to be longer than a time between successive frames, pPHYMIFSTime,.

6. A method of transmitting data from a source device to a destination device during an allocated channel time, the method comprising:
receiving a first data frame from the destination device;
transmitting a first acknowledgement (ACK) for the first data frame to the destination device;
checking whether a channel is idle for a predetermined waiting time, after the source device transmits the first ACK to the destination device;
actuating a first backoff counter according to a backoff algorithm after the predetermined waiting time elapses; and
transmitting a second data frame to the destination device when the first backoff counter reaches zero.

7. The method of claim 6, wherein the predetermined waiting time is set to be longer than a retransmission interframe space (RIFS) defined according to IEEE 802.15.3.

8. The method of claim 6, further comprising:
receiving a second acknowledgement (ACK) for the second data frame;
actuating a second back off counter according to a backoff algorithm after receiving the second ACK; and
transmitting a third data frame to the source device when the second backoff counter reaches zero.

9. The method of claim 6, further comprising:
receiving a second acknowledgement (ACK) for the second data frame; and
transmitting a third data frame to the source device after receiving the second ACK and after short interframe sequence (SIFS) elapses.

10. The method of claim 6, wherein in the checking, clear channel assessment (CCA) capabilities' of a physical (PHY) layer is used to check whether the channel is one of idle and busy.

11. A method of transmitting data from a destination device to a source device during an allocated channel time, the method comprising:
receiving a first data frame from the source device;
checking whether a channel is idle for a predetermined waiting time, after the destination device receives the first data frame from the source device;
actuating a first backoff counter according to a backoff algorithm after the predetermined waiting time elapses; and
transmitting a second data frame to the source device when the first backoff counter reaches zero.

12. The method of claim 11, wherein the predetermined waiting time is set to be longer than a time between successive frames, pPHYMIFSTime.

13. The method of claim 11, further comprising:
actuating a second backoff counter according to a backoff algorithm after the destination device transmits the second data frame to the source device; and
transmitting a third data frame to the source device when the second backoff counter reaches zero.

14. The method of claim 11, further comprising transmitting a third data frame to the source device after a time between suceessive frames, pPHYMIFSTime, elapses after transmitting the second data frame.
